(19) United States
(12) Patent Application Publication
(10) Pub. No.: US 2012/0208077 A1
(43) Pub. Date: Aug. 16, 2012

(54) METHOD FOR PRODUCING AN ELECTROCHEMICAL CELL

(75) Inventors: Claus-Rupert Hohenthanner, Hanau (DE); Jens Meintschel, Bernsdorf (DE)

(73) Assignee: LI-TEC BATTERY GMBH, Kamenz (DE)

(21) Appl. No.: 13/390,555

(22) PCT Filed: Aug. 17, 2010
(86) PCT No.: PCT/EP10/05042

§ 371 Date: Apr. 30, 2012

(30) Foreign Application Priority Data
Aug. 18, 2009 (DE) 10 2009 037 849.9

(51) Int. Cl. H01M 2/06; B29C 45/14

(52) U.S. Cl. 429/179; 264/272.14

(57) ABSTRACT

In a method for manufacturing an electrochemical cell (1), having an electrode stack (5) with at least two electrodes, which are separated from ech other by a separator, a cover (2), realized of at least two parts (4), which is closed liquid-tight, and at least two conductors (3), which are electrically connected to said electrodes and which protrude through the cover (2) to the outside, initially, in a first process step, the conductors (3) are connected to a molded part (6, 7, 8) by a molding process and in a second process step said molded part (6, 7, 8) will be connected to the cover (2).

Priority application DE 10 2009 037 849.9 as filed on Aug. 18, 2009 is fully incorporated into the present application, by means of reference.

The present invention relates to a method for manufacturing an electrochemical cell, in particular, a flat battery cell, as well as to an electrochemical cell, manufactured by such a method.

DE 600 29 123 T2 shows a galvanic cell. Here, an electrical cell in form of a roll pack is included inside a metal box. A positive and a negative conductor are provided, which are connected to electrodes of the roll pack. A ring-shaped plastic element is provided, which electrically insulates the positive pole from the metal box.

The underlying object of the present invention is to provide an improved method for manufacturing an electrochemical cell.

The underlying problem of the invention is solved by a method for manufacturing an electrochemical cell according to claim 1, as well as by an electrochemical cell according to claim 7. Advantageous embodiments and further developments of the invention are indicated in the dependent claims.

The electrochemical cell according to the invention comprises or, respectively, has essentially, an electrode stack, having at least two electrodes, which are separated from each other by a separator. Furthermore, the electrochemical cell has a cover of at least two parts, which is closed in a liquid-tight manner. At least two conductors are provided, which are electrically connected to the electrodes and which protrude through the cover to the outside. In a first process step, the conductors are connected to a molded part (“Formteil”), by a shaping process. In a second process step, the molded part is connected to the cover. The conductor preferably protrudes through the cover via an opening of the cover. The opening of the cover is, preferably, realized at a seam between the at least two parts of the cover. The molded part may seal the opening of the cover, in particular together with the conductor. To achieve this, the molded part may be connected with the cover at an opening of the cover, in particular, may be connected to the cover such that the molded part seals the opening completely and/or in a liquid-tight manner, in particular, together with the conductor. A connection between the molded part and the parts of the cover by material engagement may be provided.

According to the invention, a “conductor” refers to a device, which allow s for the flow of electrons from an electrode in the direction of an electrical load. The conductor may also be used in the opposite direction of the current flow. A conductor may be electrially connected to an electrode or, respectively, to an active electrode mass of an electrode stack, and further, be connected to a connecting cable. The shape of the conductor may be adapted to the shape of the electrode stack. Preferably, a conductor is realized in a plate-like or in a foil-like manner. Preferably, each electrode of an electrode stack is associated with its own conductor or, respectively, electrodes of the same polarity are connected to a common conductor.

According to the invention, a “cover” refers to a border that is at least partial and which confines the electrode stack vis à vis the outside. The cover is, preferably, gas- and liquid-tight such that a material exchange with the environment may not take place. The electrode stack is arranged within the cover. At least one conductor, in particular two conductors, protrude through the cover, and may serve to connect the electrode stack. However, it is also conceivable that several conductors may protrude through the cover, in particular, two or four conductors. The outwardly protruding conductors provide, preferably, the plus pole connection and the minus pole connection of the electrochemical cell.

In accordance with the invention, an “electrode stack” refers to a device, which also serves as an assembly of a galvanic or, respectively, of an electrochemical cell for the storage of chemical energy and for the delivery of electrical energy. For this purpose, the electrode stack has several plate-shaped elements, at least two electrodes, namely, an anode and a cathode, and a separator which at least partially absorbs the electrolyte. Preferably, at least one anode, one separator, and one cathode are sandwiched or, respectively, stacked above each other, wherein the separator is at least partially arranged between the anode and the cathode. This sequence of arrangement of anode, cathode, and separator may be repeated as often as desired within the electrode stack. Preferably, the plate-shaped elements are wound into an electrode-coil. In the following, the term “electrode stack” is also used for electrode-coils (“Elektrodenwickel”). Prior to the discharge of electrical energy, chemical energy as stored is converted into electrical energy. During the charging process, electrical energy that is supplied to the electrode stack is be converted into chemical energy and stored. Preferably, the electrode stack has multiple pairs of electrodes and separators. Particularly preferably, some electrodes are connected, in particular, electrically connected to each other.

Preferably, the shaping process includes at least a molding process, in particular, an injection-molding process. Preferably, the molding process is an injection-molding process. Preferably, an insulating material, in particular, a plastic material may be used as the molding material.

By means of producing the molded part using a molding process, the molded part may be made, in particular, of a material, which has a certain degree of hardness after the molding process. The closing of the cover of an electrochemical cell is often associated with pressure application on seams. Since the pressure may then, also, be applied onto a molded part, the molded parts, which have a certain hardness, may be more resilient towards stresses, associated with the manufacturing process.

Preferably during the shaping process, at least one conductor is at least partially enclosed or, respectively, injection-molded by the molded part during the shaping process. The term “at least partially enclosed” or, respectively, “at least partially injection-molded” refers, in particular, to the fact that the conductor, is at least enclosed or, respectively, injection-molded by a molded part during the shaping process. The conductor is then enclosed, preferably, in a ring-shaped manner, by two, in particular by all sides, preferably by a one-piece molded part. The molded part forms, preferably, a ring-shaped closed circumferential cover, which may, in particular, serve as a supporting surface for the opening of the cover of the electrochemical cell. The molded part is, preferably, realized to form an insulating layer between a conductor and at least one part of the cover, in particular, in the area of the opening of the cover.

The ends of the conductors may protrude from the molded part, during and/or after the molding process. The protruding ends represent, in particular, an area of the conductor, which is arranged within the cover area of an electrochemical cell in a finished electrochemical cell. Furthermore, in particular, another protruding end of the conductor provides the area of the conductor, which is arranged, in the finished electrochemical cell, on the outside of the cover of the electrochemical cell. In particular, when the shaping process is a molding process, in particular, an injection-molding process, the conductor of the molded part may be injection-molded during the shaping process. A conductor, in particular, two or more conductors may be placed in a mold and may then be, at least, partially, enclosed, in particular, injection-molded by a molding material.

In a preferred embodiment, during the molding process, at least two conductors are at least partially enclosed, in particular, injection-molded, by the same molded part. Furthermore, additional and, in particular, all conductors of an electrochemical cell may be enclosed, at least partially, by the same molded part. The term “the same molded part” means, in particular, that the molded part forms a single body, namely, a one-piece molded part. Hence, preferably, all the material of the same molded part is, preferably, spatially and physically connected with each other. Thus, a single molded part encloses, preferably, at least two conductors. The molded part insulates, preferably, two conductors against each other. The molded part may hold, preferably, two conductors against each other at a distance and thus, act as a spacer. A molded part may be firmly connected to two conductors.

Preferably, the molded part is provided in form of a sealing band. A sealing band encloses, preferably completely encloses, a single conductor in a ring-shaped manner and thereby forms, in particular, a circumferential surface area, which may serve for establishing an opening of a cover of the electrochemical cell.

In an alternative embodiment, the molded part may be in form of a sealing strip. A sealing strip encloses, in particular, two or more conductors and, in particular, encloses them in a ring-shaped manner, respectively, and forms, in particular, a circumferential surface area, which may serve for establishing an opening of a cover of the electrochemical cell.

Since the sealing strip may enclose several conductors, a constriction may be avoided, in particular, as presented on a mounting area of the cover in the area between two adjacently arranged conductors. Moreover, the manufacture of sealing means, which were so far manufactured individually, may now be combined.

In another alternative embodiment, the molded part may be made in the form of a circumferential sealing frame. A sealing frame encloses, in particular, two or more conductors. The sealing frame is, preferably, firmly connected to two conductors, in particular, by material engagement. Furthermore, the sealing frame itself has a circumferentially enclosed form, to which two halves of a cover are attached from two different sides. Thus, the sealing frame, preferably, provides the seam for two, in particular shell-shaped, halves of the cover or of shells. The advantage of such a sealing frame is that the entire seam may being evenly formed on one half of the cover, without the seam having a three-dimensional curvature in form of a recess. This simplifies the mounting and also provides a better sealing effect.

Preferably, the molded part is made as an injection-molded part. The molded part encloses at least one of the conductors, at least partially, in particular in the area of the lead-through of the conductor.

The molded part protrudes the cover, preferably, at least in the sealing area. The term “protruding” means, in particular, that the molded part protrudes in the direction of the conductor, i.e. in the direction from the cell interior to the cell exterior, and extends farther in the direction of the cell exterior than the cover. An embodiment may be provided, in which, in the area of an opening, the molded part is generally realized to be of a shape than in another area of the cover. The molded part comprises a portion, which is arranged outside the opening and which is not in contact with a part of the cover. Alternatively or in combination with this, an embodiment may be provided, in which, in the area of the opening, the cover is realized to have a smaller shape, compared to another area of the cover. The terms “smaller” or “reduced” according to the invention refers to the extension of the cover, or of the molded part, in the direction from the cell interior to the cell exterior, i.e. in the break-through direction of the opening.

In the following, the invention is explained in greater detail based on figures. The figures show:

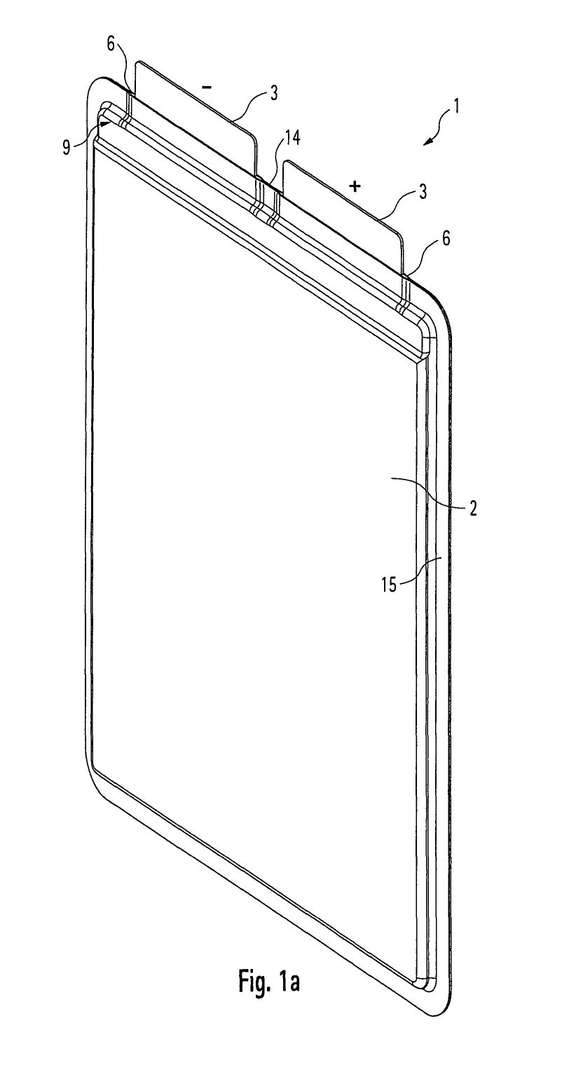

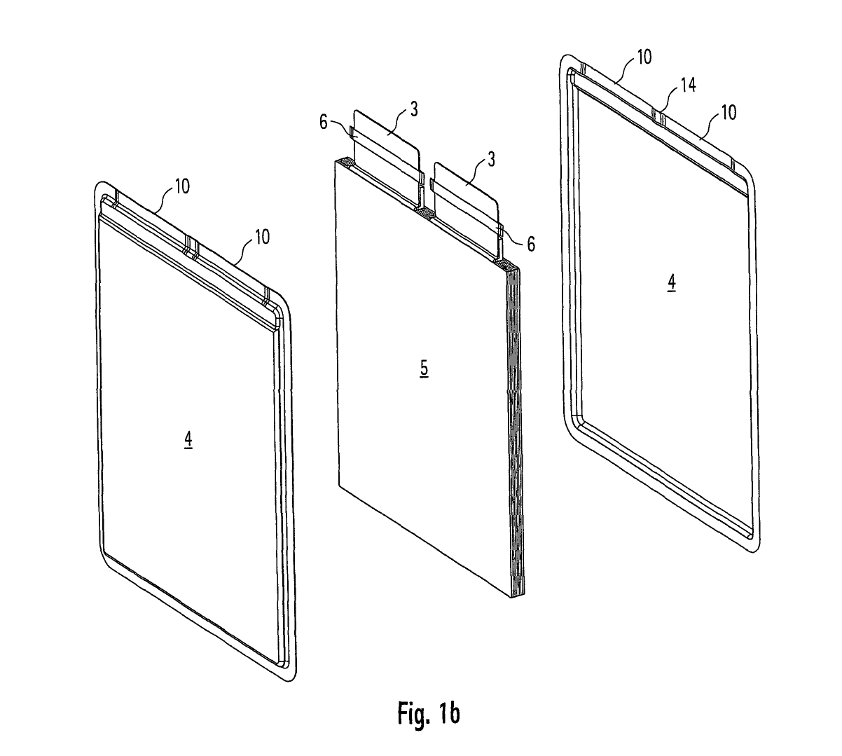

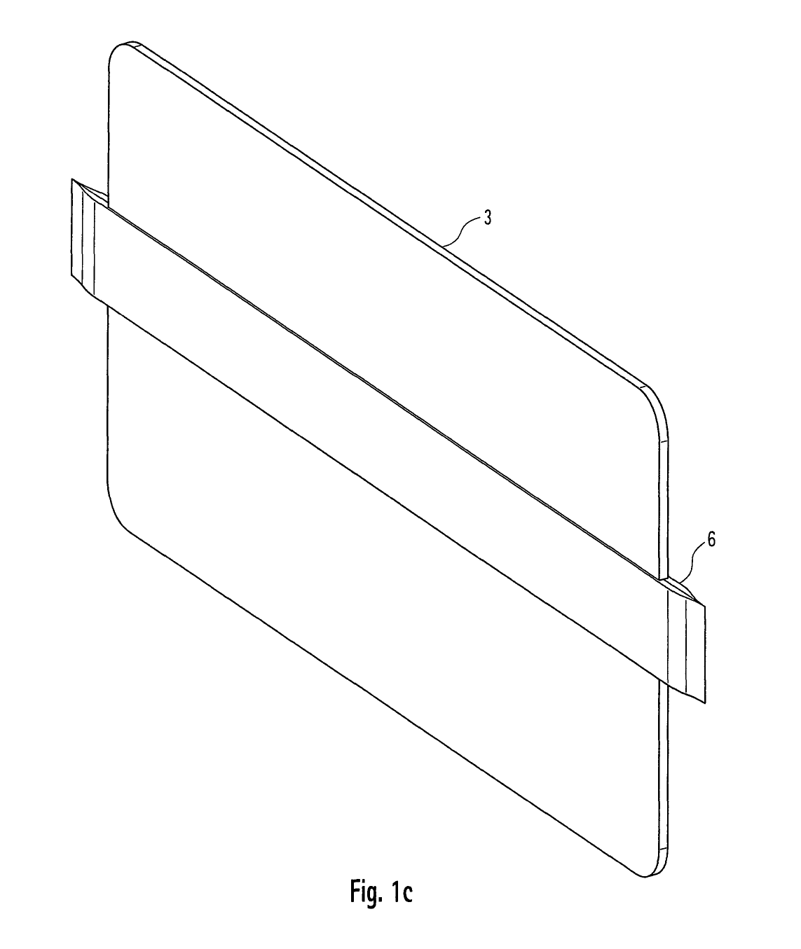

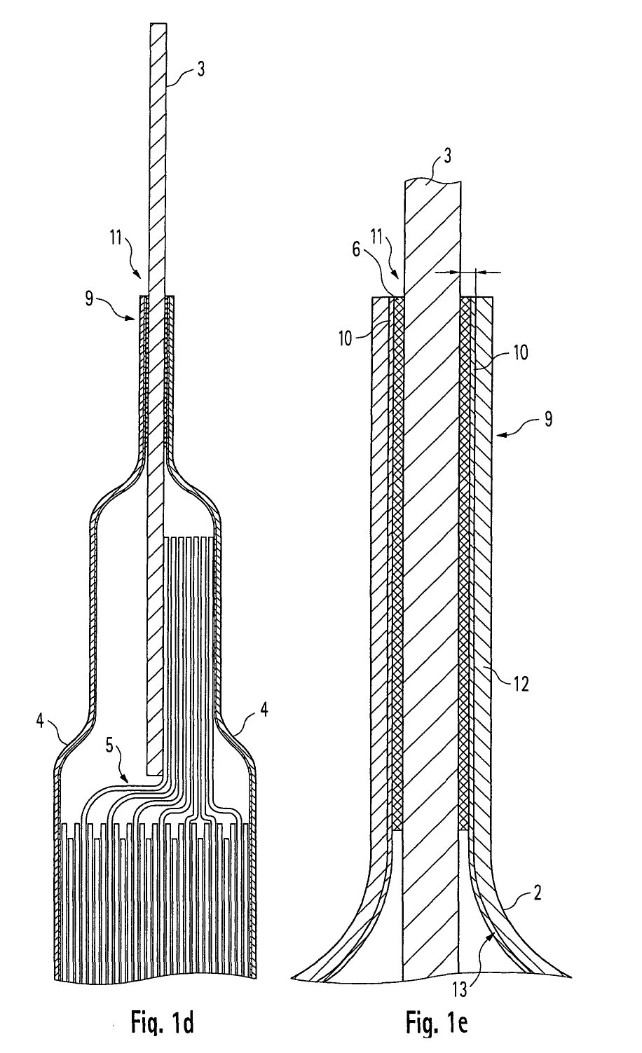

FIG. 1 an electrochemical cell according to the invention in a first embodiment

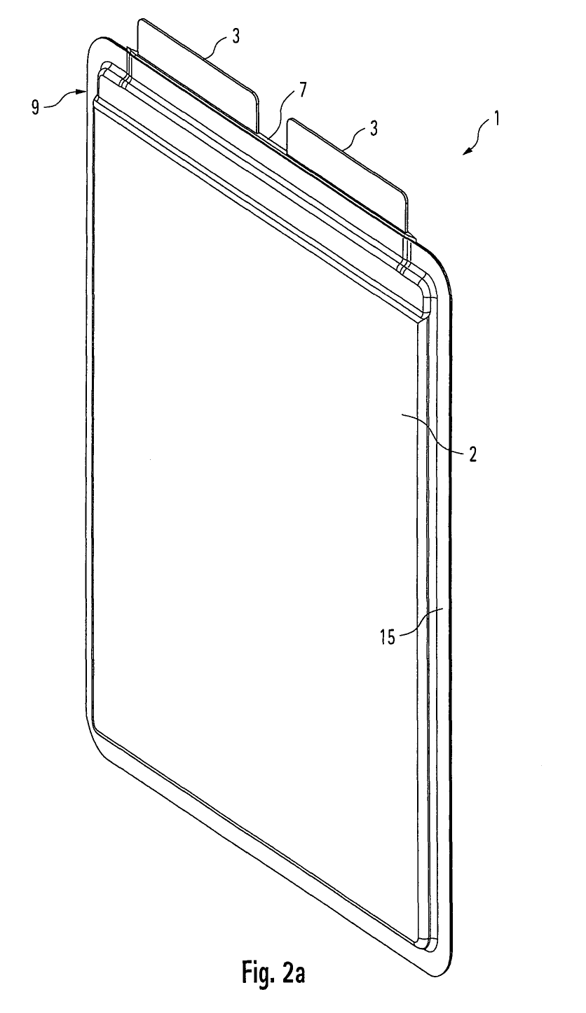

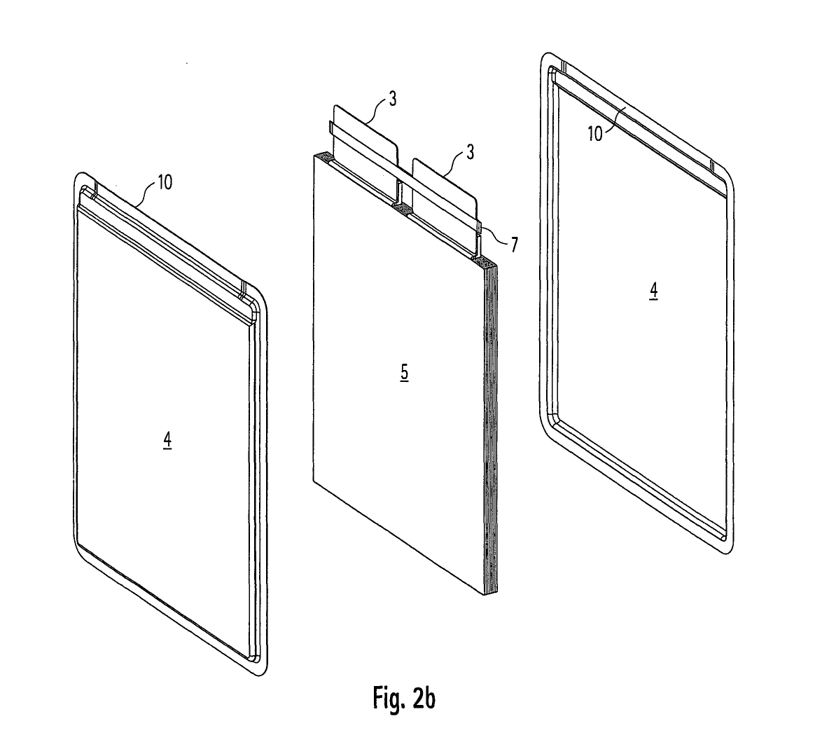

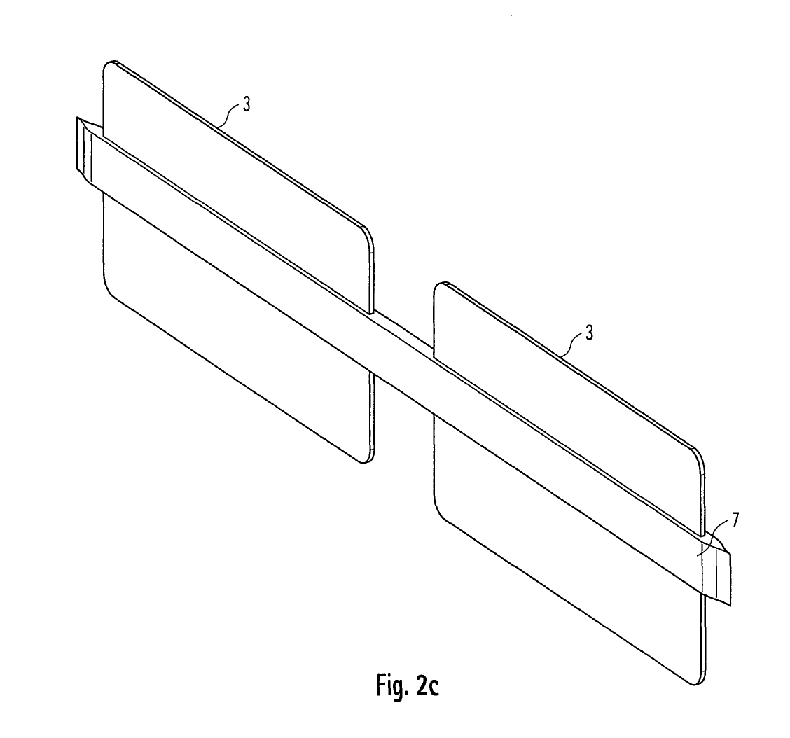

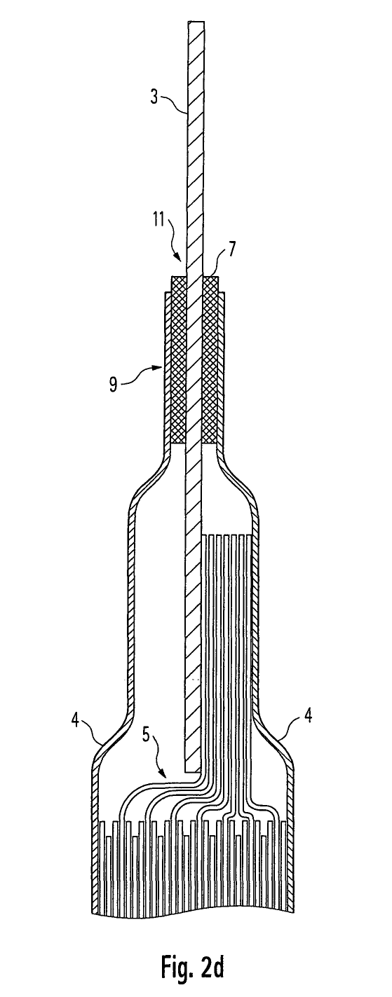

FIG. 2 a) in a perspective view,

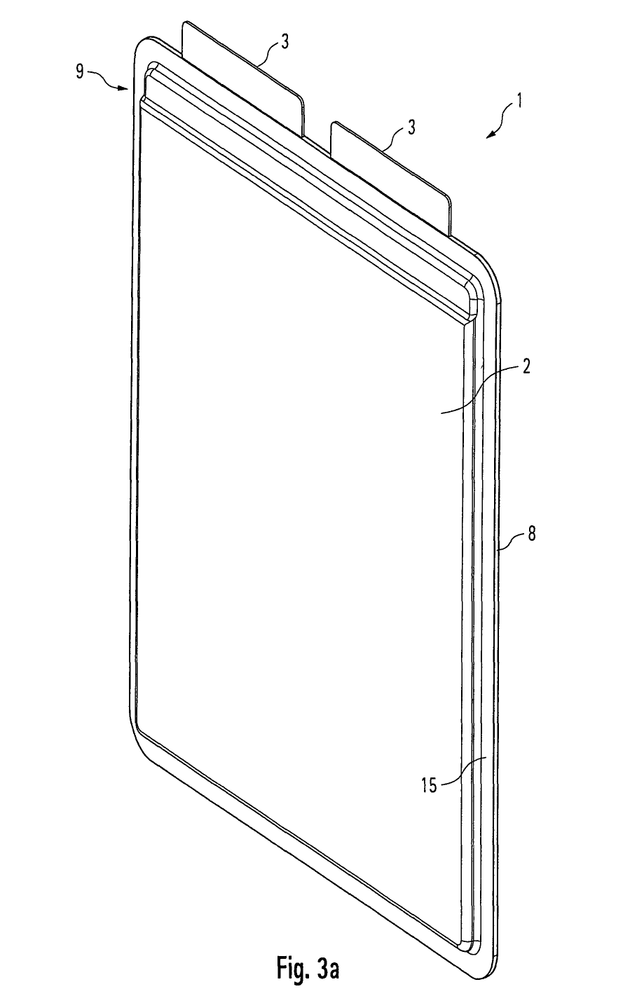

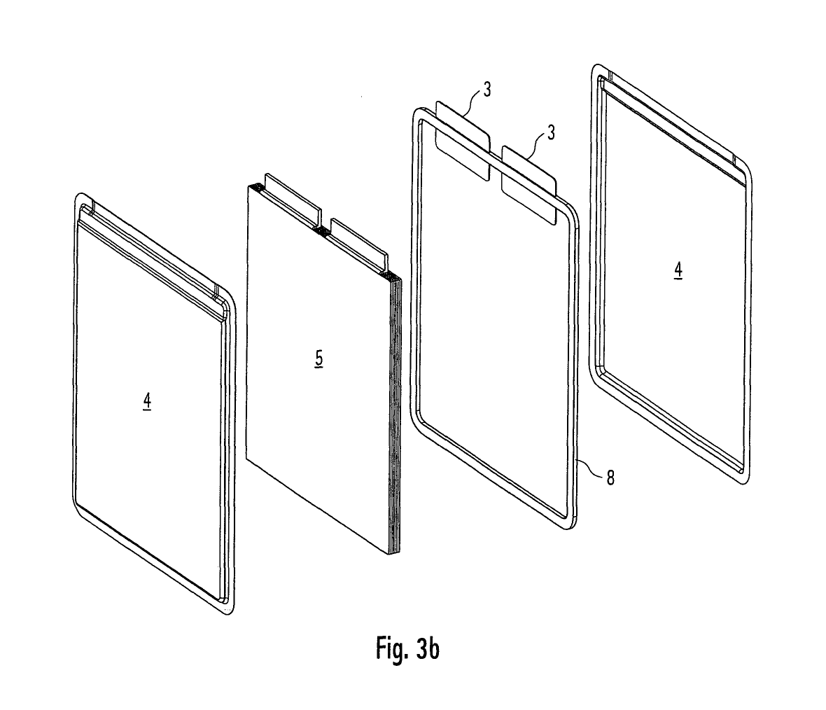

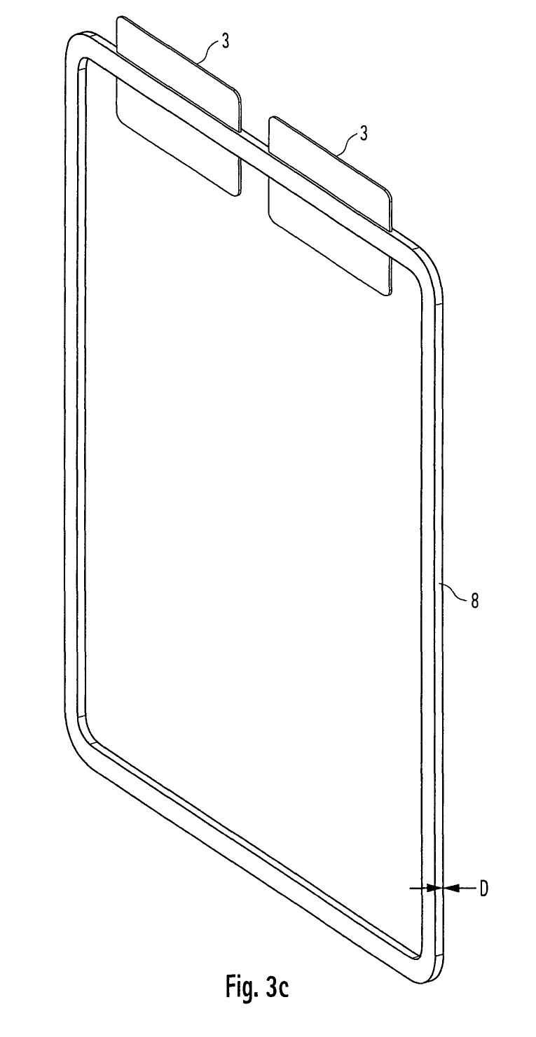

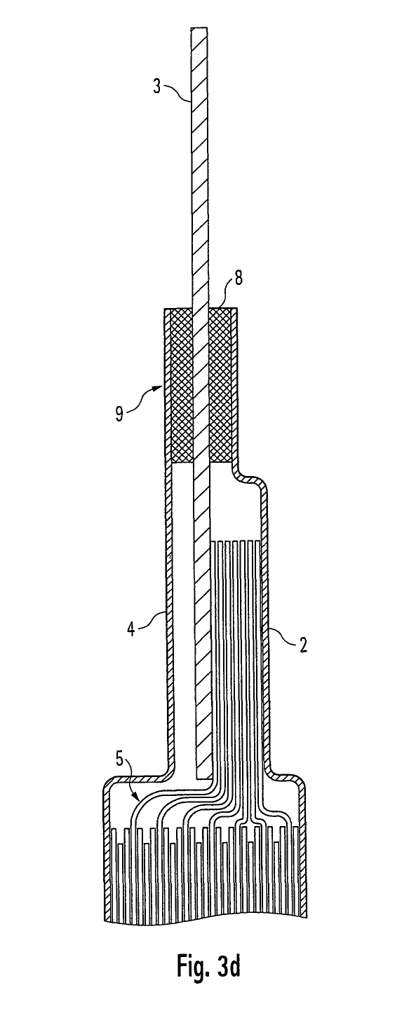

FIG. 3 b) in an exploded view,

FIG. 4 c) a conductor with a sprayed-on sealing band with details,

FIG. 5 d) in cross-section,

FIG. 6 e) the sealing area in an enlarged cross-section;

FIG. 7

FIG. 8 an electrochemical cell of FIG. 2 according to the invention in a second embodiment

FIG. 9 a) in a perspective view,

FIG. 10 b) in an exploded view,

FIG. 11 c) a conductor with sprayed-on sealing strip in detail,

FIG. 12 d) the sealing area in an enlarged cross-section;

FIG. 13

FIG. 14 an electrochemical cell according to the invention (FIG. 3) in a third embodiment

FIG. 15 a) in a perspective view;

FIG. 16 b) in an exploded view,

FIG. 17 c) a conductor with a sprayed-on sealing frame in detail,

FIG. 18 d) the sealing frame in an enlarged cross-section.

FIG. 19

FIG. 20 shows an electrochemical cell 1 according to the invention in a first embodiment. The electrochemical cell has an electrode stack 5, which is arranged inside a cover 2. Two conductors 3 are connected to the electrodes of the electrode stack 5, and said conductors protrude the cover and, as such, provide the external connections of the electrochemical cell 1. The cover 2 is realized by means of two symmetrically formed cover parts, namely shells 4.

FIG. 21

FIG. 22 Each shell 4 has a circumferential mounting area 15. By means of said mounting are 15, the two shells 4 are in contact and connected to each other. It may be seen that the shells 4 have two recesses 10 at the mounting areas 15, respectively. In the assembled condition of the shells 4, the two recesses 10 are in alignment with each other, so that an opening 11 of the cover 2 results. The area of the cover 2, in which the openings 11 are provided, is referred to as the sealing area 9. The conductors 3 protrude through the openings 11 from the interior of the cell to the exterior.

FIG. 23

FIG. 24 To insulate electrically conductors 3 vis-à-vis shells 4, conductors 3 comprise molded parts, in the sealing area 9, which are realized in the present embodiment in shape of a sealing band 6, respectively. The sealing band 6 is made of a plastic and arranged around the conductors 3 by means of an injection-molding process, namely, injection-molded around the conductors. For this, the conductor was first placed into a molding mold and then, injection-molded with an injection-molding material. For each conductor 3, a separate sealing band 6 is provided, which encloses the conductor in a ring-shape. The sealing band 6 together with the conductor 3 fill out an opening 11, respectively, and thereby, close an annular space between the recesses 10 of the shells 4 and the conductor 3.

FIG. 25

FIG. 26 The shell 4 is made of a multilayer material and has a first layer 12, which is made of aluminum. A second layer 13, which is provided within the aluminum layer 12 is made of a plastic and therefore, provides a plastic layer 13. In particular, in FIG. 1b) it may be seen that, between the two recesses 10, a constriction 14 is provided, on the mounting area 15 of the two shells 4 respectively. In the case of a closed electrochemical cell the two constrictions 14 of the two shells 4 are in contact with each other. Another means for sealing between the two constrictions 14 is thus, not provided. The shell 4 may be produced by means of deep drawing.

FIG. 27

FIG. 28 Sealing band 6 extends beyond the shells 4 along a break-through direction, which is in parallel to the direction of the conductor 3. The sealing band 6 extends farther away from the opening 11 than shell 4. This results in an improved insulation between the conductor 3 and shell 4.

FIG. 2 shows a second embodiment of the electrochemical cell 1 according to the invention, which, essentially, corresponds to the first embodiment. Hence, in the following, only the differences to the first embodiment will be discussed.

As shown, in particular, in FIG. 2b), only a single recess 10 is provided on the mounting area 15 of the shell 4, through which both conductors 3 protrude through the cover 2. Furthermore, it can be seen that the molded part is shown in the shape of a sealing strip 7, which is arranged as an injection-molded part around both conductors 3. For this, initially, both conductors were placed in a mold and then, injection-molded by injection-molding material. Sealing strip 7 encloses conductors 3 in a ring-shaped manner, respectively. Sealing strip 7 electrically insulates conductor 3 vis-à-vis shells 4. Sealing strip 7 together with the two conductors 3 fill out the opening 11. Since only one opening is provided, through which both conductors 3 protrude at the same time, according to the second embodiment, no constriction 14 is provided in the cover 2 between two openings. Also, in the second embodiment, sealing strip 7 protrudes beyond the shell 4 in the area of the opening 11.

FIG. 3 shows an electrochemical cell 1 according to the invention in a third embodiment. The third embodiment by-and-large corresponds to the second embodiment, wherein in the following, only the differences to the second embodiment will be discussed.

As shown, particularly, in FIG. 3c) the sealing means are provided in the shape of a circumferential sealing frame 8, which has a constant cross-sectional thickness D over the entire frame area. Sealing frame 8 encloses the two conductors 3 in a ring-shaped manner. Sealing frame 8 has a circumferentially closed shape, to which the two shells 4 are attached, via each of their mounting areas 15, respectively, from two different sides. Sealing frame 8 has a constant cross-sectional thickness D. over its entire circumference. No additional recesses, which form openings, are provided on the shells 4, which are brought into contact with the sealing frame 8. In other words, a circumferential opening 11 is formed between the shells 4 of the cover 5. Said opening 11 is represented by a constant gap between the two shells 4. The gap has a constant cross-sectional thickness D over its entire circumference and is completely sealed by the circumferential sealing frame 8. The sealing frame 8 is, with respect to its expansion, realized to be identical to the dimensions of the mounting area 15 of the cover 2 and is arranged over the entire range of the circumferential mounting area 15 between the two shells 4 of the cover 2. A circumferential opening 11 between mounting shells 4 is established by an arrangement of the two shells 4, which are spread apart relative to each other, which opening is filled out by the sealing frame 8 or, respectively, by the conductors 3, which are enclosed by the sealing frames 8.

### LIST OF REFERENCE NUMERALS

1 electrochemical cell
2 cover
3 conductor
4 shell
5 electrode stack
6 sealing band
7 sealing strip
8 sealing frame
9 sealing area
10 recess
11 opening
12 aluminum layer
13 plastic layer
14 constriction
15 mounting area
D cross-sectional thickness

1-13. (canceled)

14. A method for manufacturing an electrochemical cell (1), which comprises an electrode stack (5) with at least two electrodes, which are separated from each other by a separator, a cover, that is made of at least two parts (4) and that is enclosed in a liquid-tight manner, and at least two conductors (3), which are electrically connected to said electrodes, and which protrude through the cover (2) to the outside,
wherein,
in a first process step, the conductors (3) are connected to a molded part (6, 7, 8), using a shaping process, and in a second process step, said molded part (6, 7, 8) is connected to the cover (2),
wherein
the molded part is realized in the shape of a circumferential sealing frame (8), which has a circumferentially closed form, to which two halves of a cover are attached from two different sides, respectively.

15. The method according to claim 14,
wherein
the molded part (6, 7, 8) is connected to the cover (2) at an opening (11) of the cover (2).

16. The method according to claim 15,
wherein
the molding process comprises at least a molding process, in particular, an injection-molding process.

17. The method according to claim 16,
wherein
at least one conductor (3), in particular, two or more conductors (3) are inserted into a molding mold to then, become at least partially surrounded by a molding material, by means of an injection-molding process.

18. The method according to claim 17,
wherein
at least one conductor (3) is at least partially surrounded by the molded part (6, 7, 8) during the shaping process, surrounded by means of an injection-molding.

19. The method according to claim 18,
wherein
at least two conductors (3) are at least partially surrounded by the same the molded part (7, 8), surrounded by means of injection-molding.

20. An electrochemical cell (1), which is manufactured by the method according to claim 14.

21. The electrochemical cell according to claim 20,
wherein
the molded part is realized in the form of a sealing band (6).

22. The electrochemical cell according to claim 20,
wherein
the molded part is realized in the form of a sealing strip (7).

23. The electrochemical cell according to claim 20,
wherein
the molded part is realized in the shape of a circumferential sealing frame (8), which has a circumferentially closed form, to which two halves of a cover are attached from two different sides.

24. The electrochemical cell according to claim 23,
wherein
the molded part (6, 7, 8) is an injection-molded part, which at least partially surrounds the conductor (3).

25. The electrochemical cell according to claim 24,
wherein
the at least one molded part (6, 7, 8), protrudes beyond the cover (2) at least in the area of the opening (11).

26. A battery arrangement with at least one electrochemical cell (1) according to claim 25.
